(19) United States
(12) Patent Application Publication
(10) Pub. No.: US 2008/0284062 A1
(43) Pub. Date: Nov. 20, 2008

(54) INJECTION MOLDED DOLL HEAD

(76) Inventor: Peter J. Simpson, Jakarta (ID)

Correspondence Address: KOLISCH HARTWELL, P.C., 200 PACIFIC BUILDING, 520 SW YAMHILL STREET, PORTLAND, OR, 97204, US

(21) Appl. No.: 12/114,576

(22) Filed: May 2, 2008

Related U.S. Application Data
(60) Provisional application No. 60/927,699, filed on May 4, 2007.

(51) Int. Cl. B28B 7/12; B29C 45/14

(52) U.S. Cl. 264/335; 264/277

(57) ABSTRACT

In one embodiment, an injection molded doll head having at least two portions is provided. A first portion may have a first mating surface, an alignment indicator and include at least the skullcap portion of a doll head. A second portion may have a second mating surface welded to the first mating surface and may include at least a lower portion of the doll head and a concave inner cavity. The first portion and the second portion may be configured to receive rooted doll hair. Some embodiments may include doll hair rooted above and below a seam defined by the welded mating surfaces.

### RELATED APPLICATIONS

This application claims the benefit of U.S. Provisional Application No. 60/927,699, filed May 4, 2007, incorporated herein by reference in their entirety for all purposes.

### BACKGROUND

The present disclosure relates generally to molded doll heads, specifically to injection molded doll heads having two or more parts, preferably configured to receive rooted doll hair. Examples of two-piece doll heads are disclosed in U.S. Pat. Nos. 1,329,509, 3,448,540, 3,903,640, 4,892,501, and 6,217,407, and German Patent Publication No. DE1038964. Examples of molded doll heads are disclosed in U.S. Pat. Nos. 2,093,909, 3,009,284, 3,234,689, 3,628,282, 3,862,513, 6,403,003, 6,494,763, 6,089,950, 7,001,947, 7,037,455, and 7,172,721, PCT Publication No. WO0108775, and Japanese Patent Publication No. JP64046496. Publications of interest to rooting hair in doll heads include U.S. Pat. Nos. 2,626,619, 2,780,190, 2,828,702, 3,165,079, and 4,674,169. The disclosures of these and all other publications referenced herein are incorporated by reference in their entirety for all purposes.

### SUMMARY

In one embodiment, an injection molded doll head having at least two portions is provided. A first portion may have a first mating surface, an alignment indicator and include at least the skullcap portion of a doll head. A second portion may have a second mating surface welded to the first mating surface and may include at least a lower portion of the doll head and a concave inner cavity. The first portion and the second portion may be configured to receive rooted doll hair. Some embodiments may include doll hair rooted above and below a seam defined by the welded mating surfaces.

An exemplary method of making a doll head in accordance with the present disclosure may include molding a skullcap of the doll head and a lower portion of a doll head in a molding machine, wherein the skullcap portion includes a first mating surface, and the lower portion includes a second mating surface and an inner cavity. After molding, one or more doll head pieces may be removed from the molding machine. Removing the lower portion of the doll head from the molding machine may include vacuuming the lower portion from the molding machine using a vacuum extractor at least partially inserted into the inner cavity of the lower head portion. The skullcap piece may be ejected from a skullcap cavity in the molding machine. During assembly of the skullcap and the lower head portion, one or both of the mating surfaces may be heated and brought in contact with the corresponding mating surface such that the skullcap and lower head portion are fixedly, or inseparably, bonded to one another, thereby forming an assembled doll head. In some embodiments, doll hair may be rooted in the skullcap and the lower head portion.

### BRIEF DESCRIPTION OF THE DRAWINGS

FIG. 1 is an exploded view of an injection molded doll head showing a first portion and a second portion in accordance with the present disclosure, viewing the left rear and top of the head.

FIG. 2 is a rear perspective view of the assembled doll head of FIG. 1, showing a seam and an alignment indicator.

FIG. 3 is a front perspective view of a doll head having doll hair rooted in a first portion and a second portion in accordance with the present disclosure, viewing the right front and top of the head.

FIG. 4 is a cross-sectional view of an exemplary molding machine, showing mold mating portions and a robotic part handler including an extractor, viewed from the side of the machine, along a plane defined by the mold mating portions when mated together.

FIG. 5 is a first view of a vacuum extractor from the extractor of FIG. 4, shown removed from an arm of the robotic part handler. As will be more clearly seen from FIGS. 6-8, FIG. 5 is viewed generally from the rear of the head shape defined by the vacuum extractor.

FIG. 6 shows the vacuum extractor of FIG. 5 with a lower portion of a doll head removably mounted thereon.

FIG. 7 is a second view of the vacuum extractor of FIG. 5, viewed generally along line 7-7 in FIG. 5.

FIG. 8 shows the vacuum extractor of FIG. 7 with a lower portion of a doll head removably mounted thereon, viewed generally along line 8-8 in FIG. 6.

FIG. 9 is a perspective view of a molding machine having mating portions configured for injection molding of four skullcap pieces and four lower head pieces, viewed from the side of the machine, along a plane defined by the mold mating portions when mated together.

FIGS. 10a-f show, schematically, an assembly machine including a heater plate for welding a doll head in accordance with the present disclosure

FIG. 11 is a flowchart of an exemplary method of making a doll head.

### DETAILED DESCRIPTION

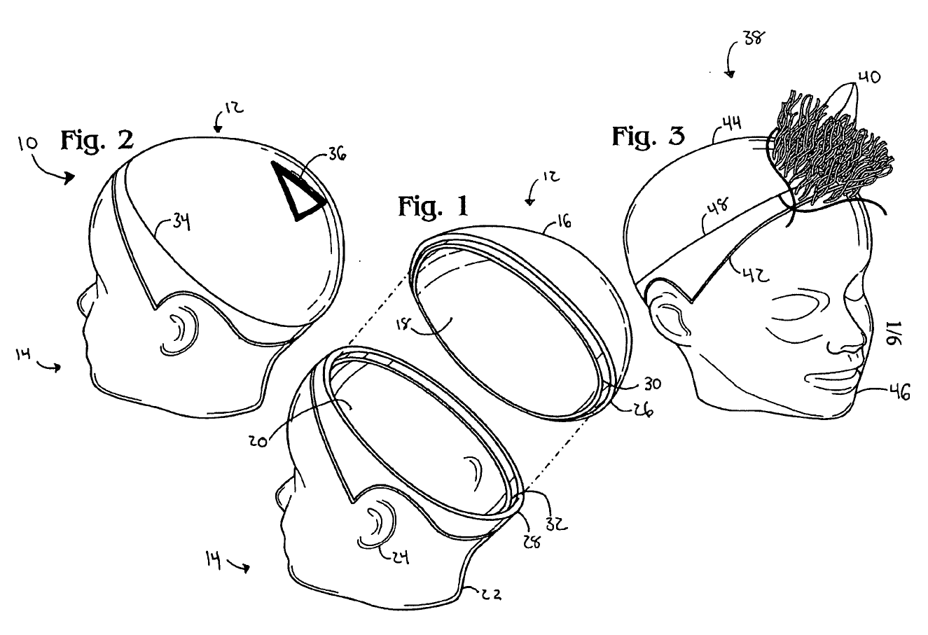

Turning first to FIGS. 1 and 2, a doll head in accordance with the present disclosure is illustrated in an exploded condition in FIG. 1, and as an assembled doll head, indicated generally at 10, in FIG. 2. Doll head 10 may include a first portion 12 and a second portion 14. First portion 12 may be described as a skullcap piece, and second portion 14 may be described as a lower head piece. Though illustrated herein as including only two portions, doll heads in accordance with the present disclosure may include more than two portions that collectively define a doll head.

Referring to FIG. 1, skullcap piece 12 may generally correspond to an upper back portion of a head, or the crown of a head, and may include an outer convex surface 16 and an inner concave surface 18. Lower head piece 14 may generally correspond to the remaining portion of doll head 10. Lower head piece 14 may include a concave inner cavity 20, the depth of which may vary in accordance with this disclosure. Lower head piece 14 may include the upper most portion of a neck 22 configured to engage, or attach to, a doll body or shoulders. Lower head piece 14 may further include ears 24 and/or other facial features.

Skullcap piece 12 may include a generally annular first mating surface 26, and lower head piece 14 may include a generally annular second mating surface 28, which is sized and shaped to correspond to first mating surface 26. First mating surface 26 may include an inner flange 30 extending partially or completely around first mating surface 26. Second mating surface 28 may include an inner recess 32 extending partially or completely around the inner circumference of second mating surface 28. Accordingly, during assembly, flange 30 of skullcap piece 12 may fit within and mate with inner recess 32 of lower head piece 14.

In other embodiments, a skullcap piece may include an annular first mating surface that is generally planar, and a lower head piece may include an annular second mating surface that is generally planar and sized and shaped to correspond to the first mating surface of skullcap piece 12.

Skullcap piece 12 and lower head piece 14 may be configured to receive doll hair. For example, the width of the walls of a skullcap piece and a lower head piece may be sufficiently thin to receive doll hair attached to a needle and inserted into and pulled back out of the wall of a doll head, known to those skilled in the art as rooted doll hair.

Alternatively, doll heads in accordance with the present disclosure are not required to have an inner recess cavity or be concave. Accordingly, a second mating surface of lower head piece may also be described as a second planar surface, and a first mating surface of a skullcap piece may be described as a first planar surface.

Referring to FIG. 2, during assembly of dolls heads, first mating surface 26 and second mating surface 28 may be joined together to define a seam 34 and thereby provide assembled doll head 10. First mating surface 26 and second mating surface 28 may be fixedly welded together such that doll head 10 is generally hollow and configured to receive rooted doll hair above and below seam 34.

An optional alignment indicator 36 may be provided in one or more portions of a doll head in accordance with the present disclosure. Alignment indicator 36 may be located on convex outer surface 16 in the form of an isosceles triangle with one corner of the triangle pointing toward the face of doll head 10. Accordingly, during assembly of doll heads in accordance with the present disclosure, skullcap piece 12 may be properly aligned with lower head piece 14.

Alignment indicator 36 may be a thin protrusion that is molded as part of convex surface 16 of skullcap piece 12, however, any suitable means for properly aligning one or more portions of the doll head together are within the scope of the present disclosure, including (but not limited to) depressions, protrusions, lines, various other shapes, etc. Additionally or alternatively, an alignment indicator may be a shape cut into the doll head material, be part of a different surface of a skullcap piece or may be located on a lower head piece.

Turning to FIG. 3, some embodiments of a doll head, indicated generally at 38, may include doll hair 40. Doll hair 40 may be sewn on, rooted on, adhered to, or may be attached to the doll head by any suitable method known to those skilled in the art. Doll hair 40 may be attached by hand (i.e., a human) or by machine, or a combination of the two.

Doll head 38 may include an optional guide 42 for identifying the proper location for attachment of doll hair 40 to a skullcap piece 44 and/or a lower head piece 46. For example, guide 42 may provide a line that is easily tracked by an operator of a sewing machine, or by a laser (or other mechanism) of an automated sewing machine, so that the doll hair may be precisely and accurately attached.

Guide 42 may be a groove that is molded into lower head piece 46 during the manufacturing process, and may generally correspond to the circumferential hairline of the doll head. Guide 42 may be described as a groove guide. Guides other than grooves that generally define and correspond to the hairline are equally within the scope of the present disclosure. For example, a protrusion rather than a groove, or simply a drawn or painted line, may similarly be incorporated in or on doll heads in accordance with the present disclosure.

Guide 42 may be a continuous line, or alternatively guide 42 may include one or more non-continuous segments. Guide 42 may be fully defined in lower head piece 46. Additionally or alternatively, guides may be provided in skullcap piece 44, in both lower head piece 46 and skullcap piece 44, partially in lower head piece 46 and partially in skullcap piece 44, and/or fully or partially in other portions of doll heads that may be present in embodiments other than the non-exclusive example illustrated herein.

A seam 48 defined by welding the mating surfaces of skullcap piece 44 and lower head piece 46 may be hidden upon the application or attachment of doll hair 40. Doll head 38 may be partially or substantially hollow such that both a skullcap piece 44 and a lower head piece 46 are configured to receive rooted doll hair 48. Seam 48 and skullcap piece 44 (and/or other portions such as an alignment indicator) may therefore at least partially be hidden by doll hair 48.

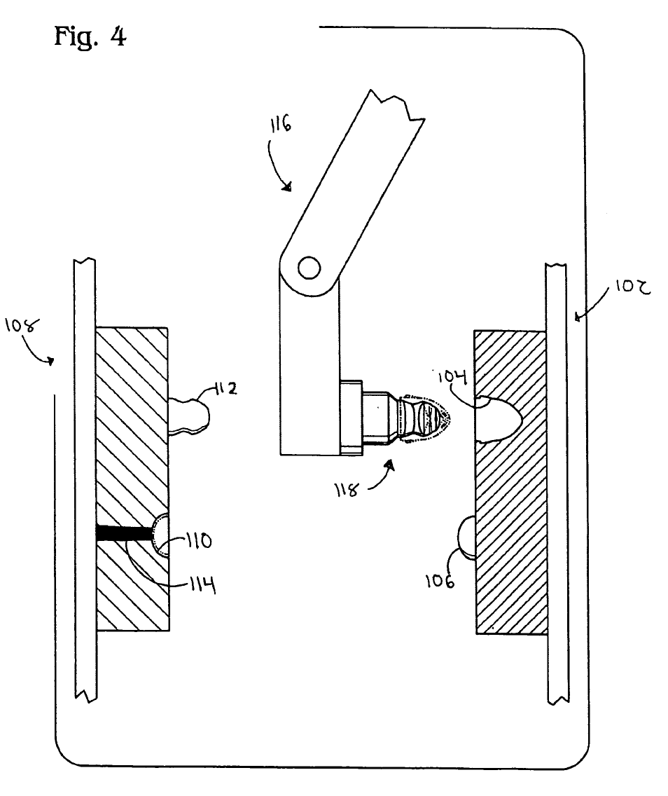

Turning now to FIG. 4, depicted is a non-exclusive example of a molding machine, indicated generally at 100, that may be used to manufacture a skullcap piece and a lower head piece of a doll head in accordance with the present disclosure. Molding machine 100 may include mold mating portions that are configured to produce one or more skullcap pieces and/or one or more lower head pieces, and may be described as a family mold, as that term is understood by those skilled in the art of injection molding.

Molding machine 100 may include a stationary side 102 that includes a lower head piece cavity 104 and a skullcap piece core 106. Stationary side 102 may be configured to receive an injection of thermoplastic material and may also be described as a hot-side. A moveable side 108 of molding machine 100 may include a skullcap piece cavity 110 and a lower head piece core 112. Moveable side 108 may be programmed to temporarily join with stationary side 102 during molding.

Molding machine 100 may include one or more ejector pins that are configured to eject a skullcap piece out of a skullcap piece cavity and/or configured to eject a lower head piece out of a lower head piece cavity. An ejector pin 114 may extend through movable side 108 to facilitate removal of skullcap piece 12 from skullcap piece cavity 110. Additionally or alternatively, an ejector pin may extend through stationary side 102 to facilitate removal of skullcap piece 12 from skullcap piece core 106.

In some embodiments, a molded doll head piece may be retained within a mold cavity after being molded. Alternatively, a molded doll head piece may be retained on a core after being molded. All means known to those skilled in the art of removing a skullcap piece or a lower head piece out of their respective cavities or from their respective cores are within the scope of this disclosure, including, but not limited to, manual extraction and/or compressed air force.

In some embodiments, molding machine 100 may include a part handler or arm 116. Part handler 116 may be robotically or automatically controlled by a computer and/or an operator. At least a portion of part handler 116 may be moveable or insertable between stationary side 102 and moveable side 108 after molding of one or more doll head pieces. Part handler 116 may include an extractor 118 configured to extract a skullcap piece or a lower head piece from a mold mating portion.

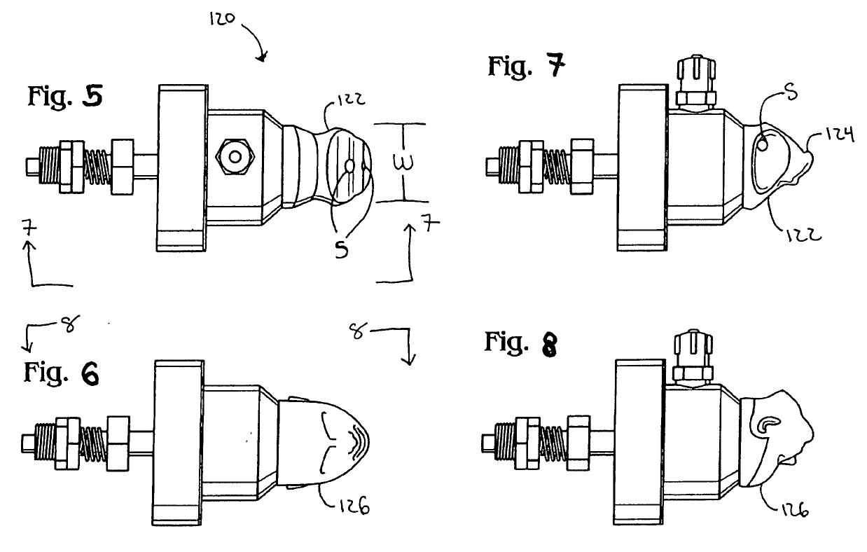

FIG. 5 is a first view of an alternative embodiment of an extractor including a vacuum mechanism to suction a doll head mold piece from a mold cavity, which may be incorporated into a molding machine in accordance with the present disclosure. A vacuum extractor 120 may include an end portion 122 having suction holes S. In some embodiments, suction holes S may positioned such that a lower head piece may collapse inwards during removal from a molding machine mold cavity.

Vacuum extractor 120 may be further configured to fit within the inner cavity of a lower head piece. For example, vacuum end portion 122 may have a width W substantially corresponding to a width of a mold core, such that end portion 122 is insertable in a molded doll head portion. FIG. 6 illustrates a first view of a lower head piece 126 positioned on vacuum extractor 120, as a molded doll head piece would be after removal from a molding machine. FIG. 7 is a second view of vacuum extractor 120 including a lip 124 to engage a portion of a molded doll head piece. FIG. 8 illustrates a second view of lower head piece 126 positioned on vacuum extractor 120.

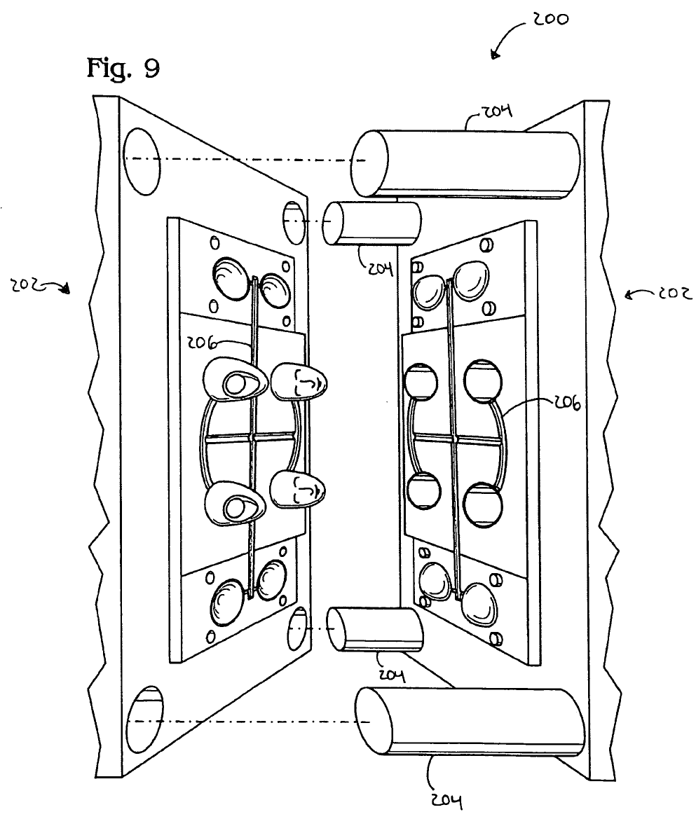

FIG. 9 is an alternative embodiment of a molding machine, specifically a multi-cavity family molding machine, indicated generally at 200, as that term is understood by those skilled in the art of injection molding. Molding machine 200 may include mold mating portions 202 configured to mold multiple skullcap pieces and multiple lower head pieces. Mold mating portions 202 may be slidably mounted on one or more rails 204 such that one or both of mold mating portions 202 may be move towards and away from one another.

Mold mating portions 202 may include partial sprue channels 206 that connect mold cavities such that, when joined, partial sprue channels 206 form a channel for receiving and distributing material during molding. Accordingly, multiple doll head pieces may be formed by a single injection of material. As understood by those skilled in the art of injection molding, a sprue may be formed in the channel after injection of material. The sprue may be attached to the molded skullcap pieces and may be cut or removed before or after assembly with a lower head peice.

A non-exclusive example of material that may be suitable for forming doll heads in accordance with the present disclosure includes thermoplastic material such as PVC 65 (shore A). Other suitable materials are disclosed in U.S. Pat. No. 6,403,003, incorporated above. The harder the material used for doll heads, the more difficult it generally is to root or sew doll hair onto the head.

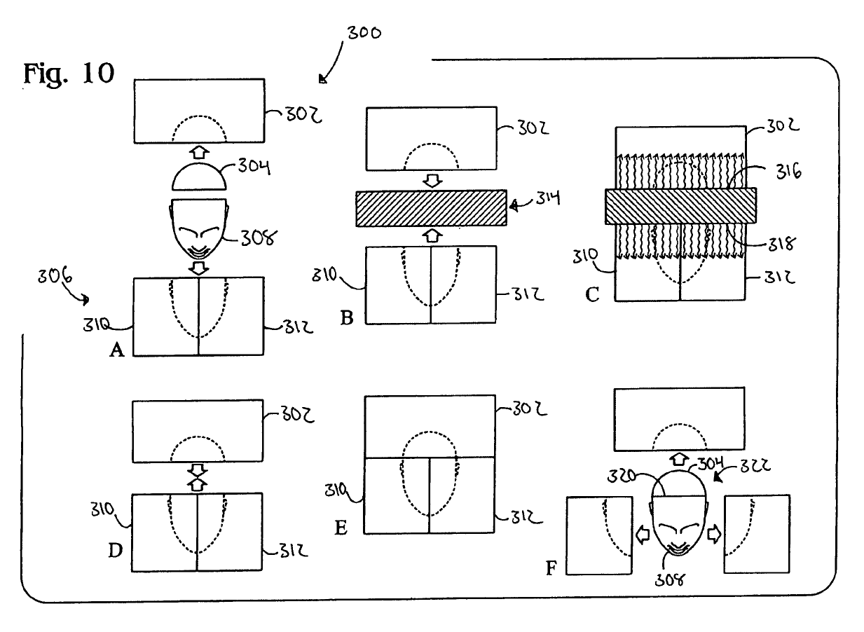

Turning now to assembly of the doll head pieces, all means known to those skilled in the art of melting or welding a skullcap piece and a lower head piece together are within the scope of the present disclosure. FIGS. 10a-f illustrates an exemplary assembly machine 300 for use in welding doll head pieces together in accordance with the present disclosure.

Turning first to FIG. 10a, assembly machine 300 may include an upper jig 302 configured to receive and retain a skullcap piece 304. Upper jig 302 may retain skullcap piece 304 using a vacuum, although any suitable method of retaining skullcap piece 304 may be used. In application, an operator of assembly machine 300 may use an alignment guide on skullcap piece 304 to determine the appropriate orientation of skullcap piece 304 in upper jig 302.

Assembly machine 300 may further include a lower jig 306 configured to receive and retain a lower head piece 308. Lower jig 306 may be a two-piece jig including a first half 310 and a second half 312 that generally sandwich lower head piece 308 there between to properly position and align lower head piece 308 with skullcap piece 304. Upper jig 302 and lower jig 306 may be aligned so that when brought together, the mating portion of skullcap piece 304 and the mating portion of lower head piece 308 properly align with each other.

As shown in FIG. 10b, assembly machine 300 may include a heater plate 314 that during operation is heated to an appropriate surface temperature for welding skullcap piece 304 and lower head piece 308 together. In application, heated heater plate 314 may be positioned between upper jig 302 and lower jig 306. The surface temperature may vary with different molding materials.

Referring to FIG. 10c, heater plate 314 may be sandwiched between upper jig 302 and lower jig 306 so that upper surface 316 of heater plate 314 comes into contact with the mating portion of skullcap piece 304 and lower surface 318 of heater plate 314 comes into contact with the mating portion of lower head piece 308.

After a predetermined length of time, during which the surfaces of the lower and upper rims are heated to a predetermined condition suitable for welding, heater plate 314 may be removed from between the upper and lower jigs, and upper jig 302 and lower jig 306 are brought together, FIG. 10d. Skullcap piece 304 and lower head piece 308 may then be welded together, FIG. 10e. As shown in FIG. 10f, skullcap piece 304 and lower head piece 308 are joined to form a seam 320 of an assembled doll head 322.

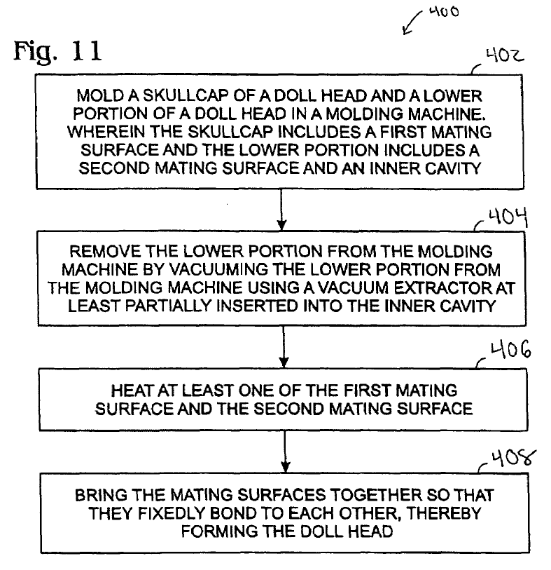

Turning now to the flowchart 400 in FIG. 11, an exemplary method of making a doll head in accordance with the present disclosure may include, at 402, molding a skullcap of the doll head and a lower portion of a doll head in a molding machine, wherein the skullcap portion includes a first mating surface, and the lower portion includes a second mating surface and a inner cavity.

After molding, at 404, one or more doll head pieces may be removed from the molding machine. Removing the lower portion of the doll head from the molding machine may include vacuuming the lower portion from the molding machine using a vacuum extractor at least partially inserted into the inner cavity of the lower head portion. Removing the skullcap piece may include ejecting the skullcap piece from a skullcap cavity in the molding machine using an ejector pin.

During assembly of the skullcap and the lower head portion, at 406, one or both of the mating surfaces may be heated and, at 408, brought in contact with the corresponding mating surface such that the skullcap and lower head portion are fixedly, or inseparably, bonded to one another, thereby forming an assembled doll head. In some embodiments, doll hair may be rooted into the skullcap piece and the lower head portions.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

Inventions embodied in various combinations and subcombinations of features, functions, elements, and/or properties may be claimed through presentation of new claims in a related application. Such new claims, whether they are directed to a different invention or directed to the same invention, whether different, broader, narrower or equal in scope to the original claims, are also regarded as included within the subject matter of the inventions of the present disclosure.

What is claimed is:

1. A doll head comprising;
a first portion having a first mating surface and an alignment indicator and including at least the skullcap portion of a doll head; and
a second portion having a second mating surface welded to the first mating surface, wherein the second portion includes at least a lower portion of the doll head and a concave inner cavity;
wherein first portion and the second portion are configured to receive rooted doll hair.

2. The doll head of claim 1, wherein the second portion has an outwardly facing surface including a guideline for identifying an area for attachment of doll hair to the doll head.

3. The doll head of claim 1, wherein the lower portion includes ears and the guideline is a substantially continuous line above the ears defining a natural hairline.

4. The doll head of claim 1, further comprising rooted doll hair in the first portion and the second portion.

5. The doll head of claim 1, wherein the first mating surface includes a peripheral flange that is mated to an inner recess of the second mating surface.

6. The doll head of claim 1, wherein the first portion and the second portion together form a substantially hollow doll head.

7. A method for making a doll head comprising;
molding a skullcap of the doll head and a lower portion of a doll head in a molding machine, wherein the skullcap includes a first mating surface, and the lower portion includes a second mating surface and a inner cavity;
removing the lower portion of the doll head from the molding machine, including vacuuming the lower portion from the molding machine using a vacuum extractor at least partially inserted into the inner cavity;
heating at least one of the first mating surface and the second mating surface; and
bringing the mating surfaces together so that the mating surfaces fixedly bond to each other, thereby forming the doll head.

8. The method of claim 7, wherein the vacuum extractor is mounted to a robotic part handler.

9. The method of claim 7, wherein heating includes applying a heater plate to the first mating surface and the second mating surface.

10. The method of claim 7, further comprising rooting doll hair to the skullcap portion of the doll head and to the lower portion of the doll head.

11. The method of claim 10, wherein the surface of the skullcap portion of the doll head is covered by the rooted doll hair.

12. The method of claim 7, wherein bringing the mating surfaces together includes aligning the skullcap portion and the lower portion using an alignment indicator.

13. The method of claim 7, further comprising ejecting the skullcap portion from the molding machine using an ejector pin.

14. The method of claim 7, wherein the vacuum extractor is configured to fit within the inner cavity of the lower portion.

15. The method of claim 7, wherein the skullcap portion defines a skullcap of a doll head and the lower portion defines the doll head below the skullcap including a portion of a doll neck, wherein the assembled doll head is substantially hollow.

16. The method of claim 7, wherein the skullcap portion and the lower portion are molded simultaneously.

17. A method for making a doll head comprising;
providing thermoplastic material;
providing a mold having mating sides defining at least one skullcap having an alignment indicator and at least one a lower portion of a doll head having a concave inner recess;
injection molding at least one skullcap and at least one lower portion of doll;
extracting the at least one lower portion from the mold using an extractor mounted on a moveable arm;
assembling the at least one skullcap and the at least one lower portion including aligning the at least one skullcap with the at least one lower portion using the alignment indicator; and
welding the at least one lower portion to the at least one skullcap to form a substantially hollow doll head.

18. The method of claim 17, further comprising ejecting the at least one skullcap from the mold using an ejector pin.

19. The method of claim 17, wherein the mold mating portions define more than one skullcap and more than one lower portion.

20. The method of claim 17, further comprising rooting doll hair into the at least one skullcap and the at least one lower portion.
